(19) United States
(12) Patent Application Publication
(10) Pub. No.: US 2007/0233477 A1
(43) Pub. Date: Oct. 4, 2007

(54) Lossless Data Compression Using Adaptive Context Modeling

(75) Inventors: Nir HALOWANI, Holon (IL); Lilia DEMIDOV, Netania (IL)

Correspondence Address: BRUCE E. LILLING;LILLING & LILLING PLLC, P.O. BOX 560, GOLDEN BRIDGE, NY, 10526, US

(73) Assignee: INFIMA LTD., Tel Aviv (IL)

(21) Appl. No.: 11/420,102

(22) Filed: May 24, 2006

Related U.S. Application Data
(60) Provisional application No. 60/787,185, filed on Mar. 30, 2006.

(51) Int. Cl. G10L 15/16

(52) U.S. Cl. 704/232

(57) ABSTRACT

The present invention is a system and method for lossless compression of data. The invention consists of a neural network data compression comprised of N levels of neural network using a weighted average of N pattern-level predictors. This new concept uses context mixing algorithms combined with network learning algorithm models. The invention replaces the PPM predictor, which matches the context of the last few characters to previous occurrences in the input, with an N-layer neural network trained by back propagation to assign pattern probabilities when given the context as input. The N-layer network described below, learns and predicts in a single pass, and compresses a similar quantity of patterns according to their adaptive context models generated in real-time. The context flexibility of the present invention ensures that the described system and method is suited for compressing any type of data, including inputs of combinations of different data types.

### BACKGROUND OF THE INVENTION

1. Field of Invention

The present invention relates to the field of systems and methods of data compression, more particularly it relates to systems and methods for lossless data compression using a layered neural network.

2. Description of the Related Art

Machine learning states that one should choose the simplest hypothesis that fits the observed data. Define an agent and an environment as a pair of interacting Turing machines. At each step, the agent sends a symbol to the environment, and the environment sends a symbol and also a reward signal to the agent. The goal of the agent is to maximize the accumulated reward. The optimal behavior of the agent is to guess at each step that the most likely program controlling the environment is the shortest one consistent with the interaction observed so far.

Lossless data compression is equivalent to machine learning. Since in both cases, the fundamental problem is to estimate the probability of an event drawn from a random variable with an unknown, but presumably computable, probability distribution.

Near-optimal data compression ought to be a straightforward supervised classification problem. We are given a pattern stream of symbols from an unknown, but presumably computable, source. The task is to predict the next symbol or set of symbols within the pattern, so that the most likely pattern symbols can be assigned the shortest codes. The training set consists of all of the pattern symbols already seen. This can be reduced to a classification problem in which each instance is in some context function of the pattern of previously seen symbols.

Until recently the best data compressors were based on prediction by partial match (PPM) with arithmetic coding of the symbols. In PPM, contexts consisting of suffixes of the history with lengths from 0 up to n, typically 5 to 8 bytes, are mapped to occurrence counts for each symbol in the alphabet. Symbols are assigned probabilities in proportion to their counts. If a count in the n-th order context is zero, then PPM falls back to lower order models until a nonzero probability can be assigned. PPM variants differ mainly in how much code space is reserved at each level for unseen symbols. The best programs use a variant of PPMZ which estimates the “zero frequency” probability adaptively based on a small context.

One drawback of PPM is that contexts must be contiguous. For some data types such as images, the best predictor is the non-contiguous context of the surrounding pixels both horizontally and vertically. For audio it might be useful to discard the noisy low order bits of the previous samples from the context. For text, we might consider case-insensitive whole-word contexts. But, PPM does not provide a mechanism for combining statistics from contexts which could be arbitrary functions of the history.

One of the motivations for using neural networks for data compression is that they excel in complex pattern recognition. Standard compression algorithms, such as Limpel-Ziv or PPM or Burrows-Wheeler are fully based on simple n-gram models: they exploit the non-uniform distribution of text sequences found in most data. For example, the character trigram “the” is more common than “qzv” in English text, so the former would be assigned a shorter code. However, there are other types of learnable redundancies that cannot be modeled using n-gram frequencies. For example, Rosenfeld combined word trigrams with semantic associations, such as “fire . . . heat”, where certain pairs of words are likely to occur near each other but the intervening text may vary, to achieve an unsurpassed word perplexity of 68, or about 1.23 bits per character (BPC), on the 38 million word Wall Street Journal corpus. Connectionist neural models are well suited for modeling language constraints such as these, e.g. by using neurons to represent letters, words, patterns, and connections to model associations.

International patent application no. WO03049014 discloses a compression mechanism which relies on neural networks. It discloses a model for direct classification, DC, is based on the Adaptive Resonance Theorem and Kohonen Self Organizing Feature Map neural models. However, the compression process according to this invention is comprised of a learning stage which precedes and is distinct from the compression process itself.

American patent no. 5134396 discloses a method for the compression of data utilizing an encoder which effects a transform with the aid of a coding neural network, and a decoder which includes a matched decoding neural network with effects almost the inverse transform of the encoder. The method puts in competition several coding neural networks which effects a same type of transform and the encoded data of one of which are transmitted, after selection at a given instant, towards a matched decoding neural network which forms part of a set of several matched neural networks provided at the receiver end. Yet learning is effected on the basis of predetermined samples.

There is therefore a need for a system and a method for utilizing the learning capabilities of a neural network to effectively maximize the compression ability of a compression tool while operating the learning process throughout the compression procedure and on all input data.

### BRIEF SUMMARY OF THE INVENTION

The present invention discloses a method for lossless compression of data. The method comprising the steps of applying at least two different context based algorithm models for creating prediction pattern of the input data; applying a neural network trained by back propagation to assign pattern probabilities when given the context as input; selecting the proper algorithm/predication for compression for each part of the data; and applying the proper algorithm on the input data. The disclosed method further comprises the steps of adding to the compressed data a header which includes compression information to be used by the decompression process. The neural network is comprised of multiple sub-neural networks. The method also comprises the step of optimizing the input data by filtering duplicate data patterns. The input data is divided into segments of variable size, implementing the method steps sequentially on each segment.

Also disclosed is a computer program for lossless compression of data. The program is comprised of a plurality of independent sub-models, wherein each sub-model provides an output of prediction of the next pattern of the input data and its probability in accordance with different context type. The program also comprises a neural network mapping module for processing the output of all sub modules, performing an updating process of the current maps of the adaptive model weights. The adaptive model includes weights representing the success rate of the different models prediction, a decoder for implementing the proper sub module on the input data and an optimizer module for filtering duplicate text patterns.

The computer program may also include at least one mixer module, for processing parts of the sub-models output by assigning weights to each model in accordance with the prediction pattern success rate. The output of each mixer is fed to the neural network mapping module. The neural network may be comprised of multiple sub-neural networks. The input data may be divided into segments of variable size, implementing the method steps sequentially on each segment.

### BRIEF DESCRIPTION OF THE SEVERAL VIEWS OF THE DRAWINGS

These and further features and advantages of the invention will become more clearly understood in the light of the ensuing description of a preferred embodiment thereof, given by way of example, with reference to the accompanying drawings, wherein—

FIG. 1 is a block diagram schematically illustrating the coding and decoding process in accordance with the preferred embodiments of the present invention;

FIG. 2 is a block diagram illustrating the logical structure of adaptive model in accordance with the preferred embodiments of the present invention;

FIG. 3 is an illustration of a graph of the mapping preformed by the neural layers map model;

FIG. 4 is a flowchart illustrating the encoding process in accordance with the preferred embodiments of the present invention;

FIG. 5 is a flowchart illustrating the decoding process in accordance with the preferred embodiments of the present invention.

### DETAILED DESCRIPTION OF THE PREFERRED EMBODIMENTS

The present invention is a new and innovative system and method for lossless compression of data. The preferred embodiment of the present invention consists of a neural network data compression comprised of N levels of neural network using a weighted average of N pattern-level predictors. This new concept uses context mixing algorithms combined with network learning algorithm models. The disclosed invention replaces the PPM predictor, which matches the context of the last few characters to previous occurrences in the input, with an N-layer neural network trained by back propagation to assign pattern probabilities when given the context as input. The N-layer network described below, learns and predicts in a single pass, and compresses a similar quantity of patterns according to their adaptive context models generated in real-time. The context flexibility of the present invention ensures that the described system and method is suited for compressing any type of data, including inputs of combinations of different data types.

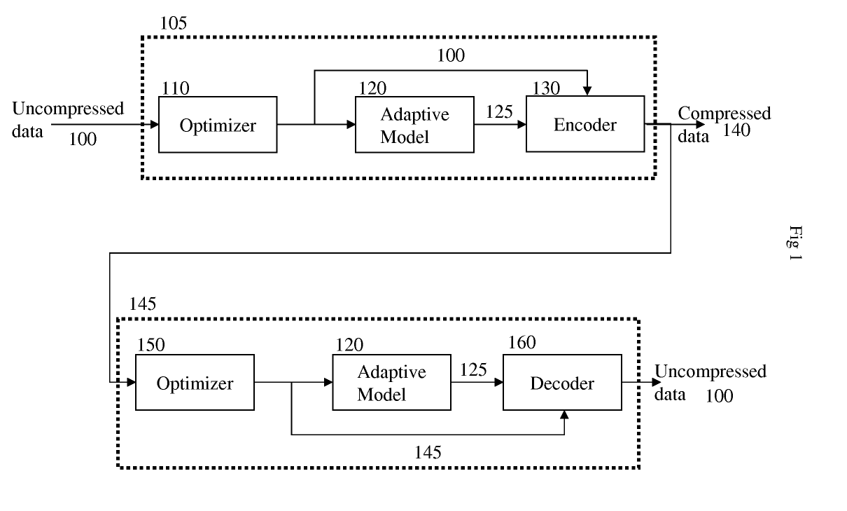

FIG. 1 is a block diagram illustrating the coding and decoding procedures. Compression model 105 receives uncompressed data 100 and outputs compress data 140. Similarly, the input of decompression model 145 is compressed data 140 and its output is uncompressed data 100. Due to the lossless compression method used in compression model 105 and decompression model 145, the uncompressed data outputted by decompression model 145 is a full reconstruction of the uncompressed data inputted into compression model 105. In compression model 105 the data is first analyzed by optimizer 110 and then by adaptive model 120. Optimizer 110 identifies reoccurring objects which were already processed by the system. As a reoccurring object is identified, the object is not processed again and the learned patterns are simply implemented on it. Output data 125 from adaptive model 120 reflects the accumulative information learned by the system about data 100 which enables encoder 130 to improve its compression abilities. Encoder model 130 then receives data 125 from adaptive model 120 as well as the uncompressed data 100 and produces compressed data 140.

The operation of decompression model 145 reproduces the steps of compression model 105 to fully restore uncompressed data 100. According to one embodiment of the present invention the compression model may add to compressed data 140 a header which includes compression information, specifying for decompression model 145 a decompression protocol. While this embodiment may significantly reduce decompression time, its major shortcoming is that adding such a header to the compressed data would increase the volume of the compressed data and reduce the compression efficiency rate of the compression model. Thus, according to the preferred embodiments of the present invention decompression model 145 receives only compressed data 140 as input. Compressed data 140 is first analyzed by optimizer 150 and then by adaptive model 120. Adaptive model 120 in decompression model 145 is identical to that used in compression model 105. Decoder model 170 receives output data 125 from adaptive model 160 and compressed data 140 and outputs decompressed data 100.

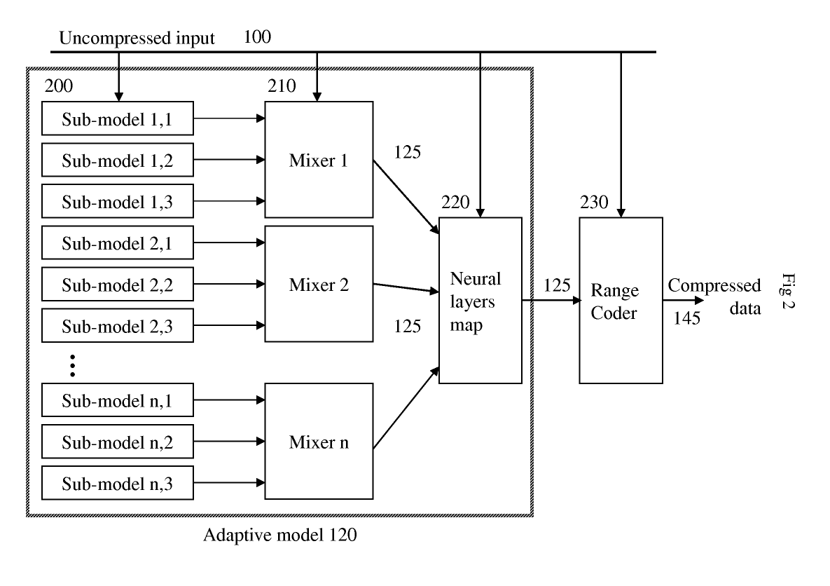

FIG. 2 is a block diagram illustrating the logical structure of adaptive model 120 in accordance with the preferred embodiments of the present invention. Adaptive model 120 consists of a plurality of sub-models 200 (sub-model 1,1 to sub-model n,3) and mixer models 210 (mixer 1 to mixer n), whereas each mixer model 210 receives input of compression prediction from three sub-models 200. Adaptive model 120 represents a weighted mix of independent sub-models 200, whereas each sub-model 200 prediction is based on different contexts. Sub-models 200 are weighted adaptively by mixer 210 to favor those making the best pattern predictions. The outputs of two independent mixers 210 are averaged in accordance with sets of weights selected by different contexts. The neural layer map 220 add each new mixers predication to the learning model and maps to the accumulated probability predication which is based on previous experience and the current context. This final estimate of predication pattern is then fed to encoder 230.

Sub-models 200 are context models, each adapt to suit a different type of data pattern. According to the preferred embodiments of the present invention there is no limitation on the number of sub-models 200 which may be implemented. However, while increasing the types of sub-models increases the compression efficiency of the present system, the total number of sub-models 200 also directly influences its processing time. Thus, the total number of sub-models 200 poses a tradeoff between the efficiency and speed of operation which may be controlled by a predefined rate which is set in the initializing procedure of the system. The outputs of these sub-model network 200 are combined using a second layer of neural network of mixers 210, which are then fed through several stages of adaptive neural maps 220 before being processed by the segment coder 230; the segment size is variable and is determined by the current predication. Model 220 is a stationary map combined with adaptive context models and their respective prediction. The creation of map 220 involves the following processes: the mixers predictions are processed and divided into segments of a fixed size to combine with previous processed contexts predictions resulting in accumulated predication patterns, this predication patterns are interpolated between two adjacent quantized values of the mixer predication. The segments are of fix size to allow comparison with previous predications.

The N-layer neural network described herein is used to combine a large number of sub-models 200 which independently predict their compression probability. Before the compression stage begins the encoder 130 is informed about the number of models which are used in the current block pattern stream. Each segment in the range is mapped to a corresponding model 200 which is adaptively added to the neural layers map 220 weighting stage with the summarized output conclusions of mixers 210. The network computes the probability of the next pattern in accordance with the selected model. While according to the preferred embodiment of the present invention the disclosed compression algorithm produces no data loss, according to additional embodiment a threshold of data loss may be determined by the user. Having performed the initial probability calculation, the system is trained to predict the results of the next input data.

The following are examples for the types of mapping strategies which may be implemented in the preferred embodiments of the present invention: ran map, stationary map, non-stationary map and match model. The ran map is best suited for consecutive repetitive occurrences of pattern combinations. The ran map is highly adaptive and quickly discards non-repetitive patterns searching for new ones. The stationary map is most suited for text inputs, it presupposes uniform input patterns. The non-stationary map is a combination of the ran map and the stationary map. According to the non-stationary mode of operation it searches for the repetitive reappearance of new patterns, like the run map, but retracts to predicted patterns when none are found. The non-stationary map is best suited for media content such as audio and video. The match model searches for reoccurring patterns which are not necessarily consecutive.

A context mixer works as follows. Since the input data is represented as a pattern stream, for each pattern within the pattern stream, each sub-model 200 independently outputs two numbers, n0 and n1, which are measures of evidence (representing the model predications) that the next pattern exists (0—not exists or 1—exists), respectively. Taken together, it is an assertion by the sub-model 200 that the next pattern will be of type n1 with probability n1/n or 0 with probability n0/n. The relative confidence of the sub-model 200 in this prediction is n=n0+n1. Since sub-models 200 are independent, confidence is only meaningful when comparing two predictions by the same sub-model 200, and not for comparing sub-models 200. Instead the sub-models 200 are combined by weighting summation of n0 and n1 over all of the sub-models 200 by the mixer model 210 according to the following formulas:

Given that wᵢ the weight of the i'th sub-model and e>0 is a small constant to guarantee that S0, S1>0 and 0<p0, p1<1, S0=e+Sᵢ wᵢn0ᵢ is the evidence of pattern 0 in this sub-model, and S1=e+Sᵢ wᵢn1ᵢ is the evidence of pattern 1. These formulas indicate the evidence of a particular pattern. S=S0+S1 is the sum of evidence for a particular pattern. p0=S0/S calculates the probability that the next pattern is of type 0 and p1=S0/S calculates the probability that next pattern is of type 1. These formulas enable providing the final result in binary output. It represents the level of confidence that the next set of data may be predicted.

After coding each pattern, the weights are adjusted along the cost gradient in weight space to favor the models that accurately predicted the last pattern. For example, if x is the pattern stream just coded the cost of optimally coding x is log 2 1/px bits. Taking the partial derivative of the cost with respect to each wᵢ in the above formulas, with the restriction that weights cannot be negative, we obtain the following weight adjustment:
wᵢ [symbol] max[0, wᵢ+(x−p1)(Sn1ᵢ−S1nᵢ)/S0S1]

At the learning stage the neural layers map model 220 further adjusts the probability output from the mixer models 210 to agree with the actual experience and calculate the weighting average of the p(x) returned from the mixers. For example, when the input is random data, the output probability should be 0.5 regardless of what the output of sub-models 200 is. Neural layers map model 220 learns this by mapping all input probabilities to 0.5.

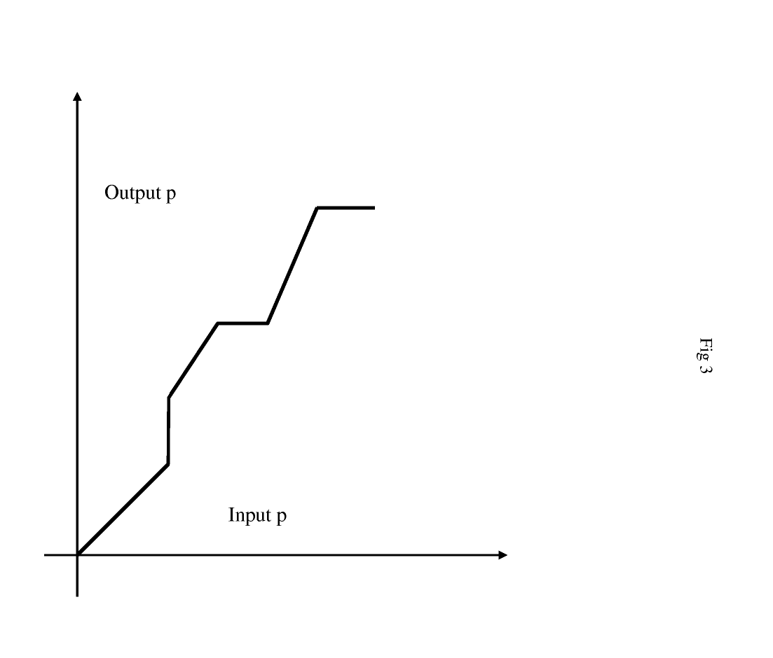

FIG. 3 is an illustration of a graph of the mapping preformed by the neural layers map model 220. Neural layers map model 220 maps the probability p back to p using a piecewise linear function with 2ˆn (n-layers) segments. Each vertex is represented by a pair of 8-bit counters (n0, n1) except that now the counters use a stationary model. When the input is p and a 0 or 1 is observed, then the corresponding count (n0 or n1) of the two vertices on either side of p are incremented. When a count exceeds the maximum, both counts are halved. The output probability is a linear interpolation of n1/n between the vertices on either side. The vertices are scaled to be longer in the middle of the graph and short near the ends. The initial counts are set so that p maps to itself. Neural layers map model 220 is context sensitive. There are 2ˆn (n-layers) separately maintaining the neural layers map model 220 functions, selected by the 0-N bits of the current (partial) pattern and the 2 high order bits of the previous one, whether the data is text or binary, using the same heuristic as for selecting the mixer context. The final output to the encoder is a weighted average of the neural layers map model 220 functions input and output, with the output receiving ¾ of the weight: p:=(3 output(p)+p)/4.

To summarize, the adaptive context models are mixed by up to N layers of several hundred nodes of neural networks selected by a context. The outputs of these networks are combined using a learning network and then fed through two stages of adaptive probability maps before range coding. Range coder is a stationary map combining a context and an input probability. The input probability is stretched and divided into segments to combine with other contexts. The output is interpolated between two adjacent quantized values of extend (p1).

Encoder 130 receives as input a buffer block pattern to be compressed. Its output is a temporary block buffer. Encoder 130 determines whether a coding is to be applied based on pattern type, and if so, which one. Encoder 130 may use lots of resources (memory, time) and make multiple calculations on the pattern buffer. The buffer pattern type is stored during compression, length of which depends on the types which are implemented in the context layers.

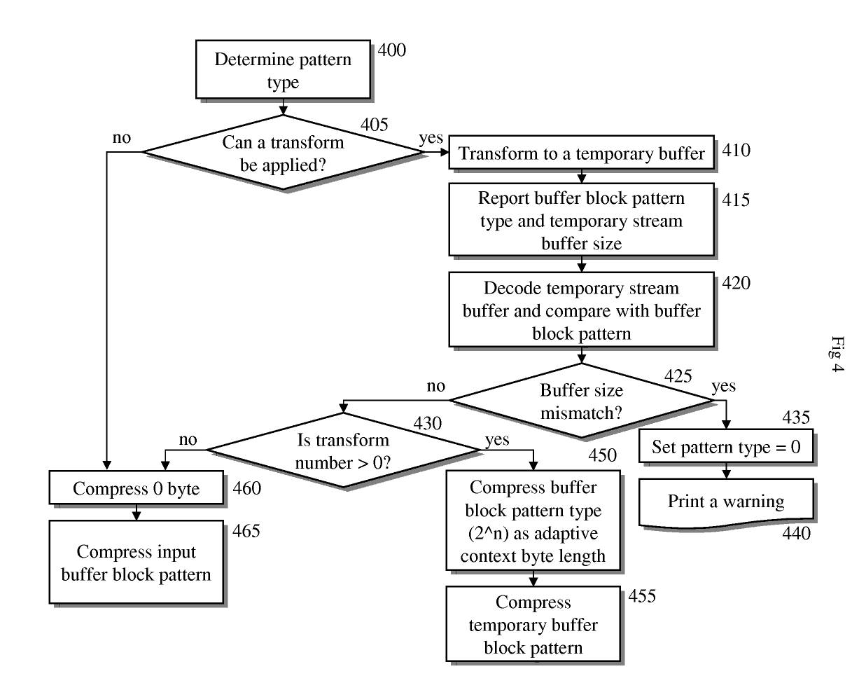

FIG. 4 is a flowchart illustrating the compression process in accordance with the preferred embodiments of the present invention. The compression of each block of pattern includes the following steps: First, the type of pattern is determined (step 400), then the system checks whether the coding may be applied (step 405). Provided that the transform may be applied the pattern is transformed and registered in a temporary buffer (step 410). The system then receives information about the buffer block pattern type and temporary stream buffer size (step 415) and the temporary stream buffer is decoded and compared with the original buffer block pattern (step 420). The system then checks whether a mismatch is found while comparing the buffers or if the decoder reads wrong number of bytes (step 425), if a mismatch was found the pattern type is set to zero (step 435) and a warning is reported (step 440). If no mismatch is found, the system checks whether the coded number is greater than zero (step 430). Provided that the transform number is greater than zero, buffer block pattern type is compressed as an adaptive context byte length (step 450) and temporary buffer block pattern is compressed and progress is reported (step 455). If the coded number is not greater than zero, 0 bytes are compressed (step 460) and input buffer block pattern is compressed and progress is reported (step 465).

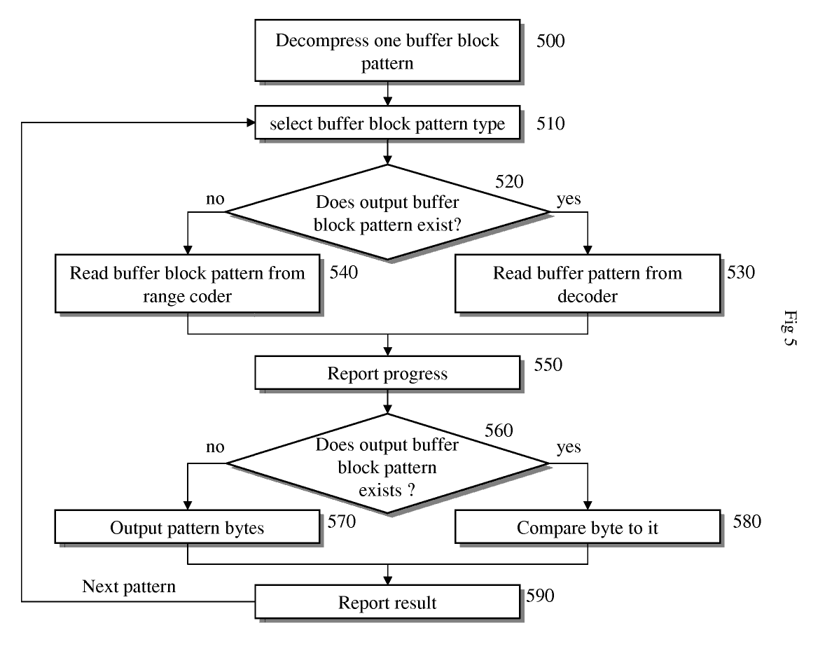

FIG. 5 is a flowchart illustrating the decoding process in accordance with the preferred embodiments of the present invention. As stated above, according to the preferred embodiments of the present invention the decoder performs the inverse transformation of the encoder. The operation of the decoder is relatively fast and uses few computation resources, and it is stream oriented, running in a single pass. The decoder receives input either from a stream or from the range decoder. Each call to the decoder returns a single decoded pattern. The decompression process includes the following steps: first, one buffer block pattern is decompressed (step 500) and according to it the buffer block pattern is selected (step 510). For each pattern in the original buffer the system checks whether buffer block pattern type is greater than zero (step 520). If the buffer block pattern type is greater than zero the buffer patterns is read from the decoder (step 530), else it is read from the range coder (step 540). Next, progress is reported (step 550) and the system checks whether output buffer block pattern exists (step 560). Provided that the output buffer block pattern exists then the system compares output pattern size to it (step 580), else the system outputs pattern bytes (step 570). Results are then reported (step 590) and the procedure repeats itself with the next pattern from step 510.

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for lossless compression of data, said method comprising the steps of
applying at least two different context based algorithm models for creating prediction pattern of the input data;
applying a neural network trained by back propagation to assign pattern probabilities when given the context as input;
selecting the proper algorithm/predication for compression for each part of the data;
applying the proper algorithm on the input data.

2. The method of claim 1 further comprising the steps of: adding to the compressed data a header which includes compression information to be used by the decompression process.

3. The method of claim 1 wherein the neural network is comprised of multiple sub-neural networks.

4. The method of claim 1 further comprising the step of optimizing the input data by filtering duplicate data patterns.

5. The method of claim 1 wherein the input data is divided into segments of variable size, implementing the method steps sequentially on each segment.

6. A computer program for lossless compression of data, said program comprised of:
a plurality of independent sub-models, wherein each sub-model provides an output of predication of the next pattern of the input data and its probability in accordance with different context type,
a neural network mapping module for processing the output of all sub modules, performing an updating process of the current maps of the adaptive model weights, wherein the adaptive model includes weights representing the success rate of the different models prediction.
a decoder for implementing the proper sub module on the input data.

7. The computer program of claim 6 further comprising an optimizer module for filtering duplicate text patterns.

8. The computer program of claim 6 further comprising at least one mixer module, for processing parts of the sub-models output by assigning weights to each model in accordance with the prediction pattern success rate, wherein the output of each mixer is fed to the neural network mapping module.

9. The computer program of claim 6 wherein the neural network is comprised of multiple sub-neural networks.

10. The computer program of claim 6 wherein the input data is divided into segments of variable size, implementing the method steps sequentially on each segment.
